(19) United States
(12) Patent Application Publication
(10) Pub. No.: US 2018/0089633 A1
(43) Pub. Date: Mar. 29, 2018

(54) COST BASED AUTO-NEGOTIATION OF SUITABLE MEETING TIMES

(71) Applicant: MICROSOFT TECHNOLOGY LICENSING, LLC, Redmond, WA (US)

(72) Inventors: Warren Johnson, Seattle, WA (US); Gautam Bhakar, Redmond, WA (US)

(73) Assignee: MICROSOFT TECHNOLOGY LICENSING, LLC, Redmond, WA (US)

(21) Appl. No.: 15/275,056

(22) Filed: Sep. 23, 2016

(51) Int. Cl. G06Q 10/10; G06Q 40/00

(52) U.S. Cl. CPC G06Q 10/1095; G06Q 40/12

(57) ABSTRACT

A meeting service with cost based meeting time and location optimization is provided. In some examples, costs may be assigned to time fragments in individual users' calendars based on time of day, day of week, other events in the schedules, user behavior, and external factors. In case of a single meeting scheduling, a deadline for the meeting may also be factored into the cost. A scheduling agent may auto-negotiate among attendees of a meeting to determine a lowest cost time for the meeting. In other examples, calendars of multiple users may be optimized on a regular basis or on-demand by re-negotiating existing meetings. User preferences and organizational policies may be used to provide constraints or adjust cost values. Historic data and acceptance of suggested meeting times may be used to learn and adjust a meeting scheduling model. In further examples, similar approaches may be applied to determine suitable meeting locations.

### BACKGROUND

Calendar systems provide a variety of tools that assist users in managing tasks, meetings, and their overall schedules. In a hosted service with a large number of subscribers, or in cross-service scenarios, users are able to check each other's schedules, find suitable meeting times and places. However, with increasingly busy schedules of people, different types of meetings and settings make it a challenge to manually find a suitable time and place for a number of people to meet. Automated services typically analyze schedules and set meeting based on rigid rules such as, first available time or place. In practice, a large number of physical (such as location of users) and abstract (whether a user would prefer to meet or not) factors may affect a meeting schedule, which may not be considered by a rigid, rule based scheduler.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to cost based auto-negotiation of suitable meeting times. In some examples, calendar information associated with a plurality of users may be received and cost values may be assigned to time fragments in each of the plurality of users' calendars. A suitable meeting time may be auto-negotiated for a meeting to be attended by at least some of the plurality of users based on selecting a lower cost time fragment for the meeting. One or more suitable meeting times may be determined as a result of the auto-negotiation and suggested to the at least some of the plurality of users for selection.

These and other features and advantages will, be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes an example network environment where a system to provide cost based auto-negotiation of suitable meeting times may be implemented;

FIG. 2 illustrates conceptually cost based auto-negotiation of suitable meeting times;

FIG. 3 illustrates an example, meeting scheduling user interface for a system with cost based auto-negotiation of suitable meeting times;

FIG. 4 illustrates example components in providing cost based auto-negotiation of suitable meeting times for defragmentation of multiple calendars;

FIG. 5 illustrates example components in providing cost based auto-negotiation of suitable meeting times for scheduling a meeting;

FIG. 6 is a networked environment, where a system according to embodiments may be implemented;

FIG. 7 is a block diagram of an example general purpose computing device, which may be used to provide cost based auto-negotiation of suitable meeting times; and

FIG. 8 illustrates a logic flow diagram of a method to provide cost based auto-negotiation of suitable meeting times.

### DETAILED DESCRIPTION

As briefly described above, embodiments are directed to cost based auto-negotiation of suitable meeting times. In some examples, costs may be assigned to time fragments in individual users' calendars based on time of day, day of week, other events in the schedules, user behavior, and external factors. In case of a single meeting scheduling, a deadline for the meeting may also be factored into the cost. A scheduling agent may auto-negotiate among attendees of a meeting, to determine a lowest cost time for the requested meeting. In other examples, calendars of multiple users may be optimized on a regular basis or on-demand by re-negotiating existing meetings. User preferences and organizational policies may be used to provide constraints or adjust cost values. Historic data and acceptance of suggested meeting times may be used to learn and adjust a meeting scheduling model. In further examples, similar approaches may be applied to determine suitable meeting locations.

In the following detailed description, references are made to the accompanying drawings that form a part hereof, and in, which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for providing a calendar service with cost based auto-negotiation of suitable meeting times. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

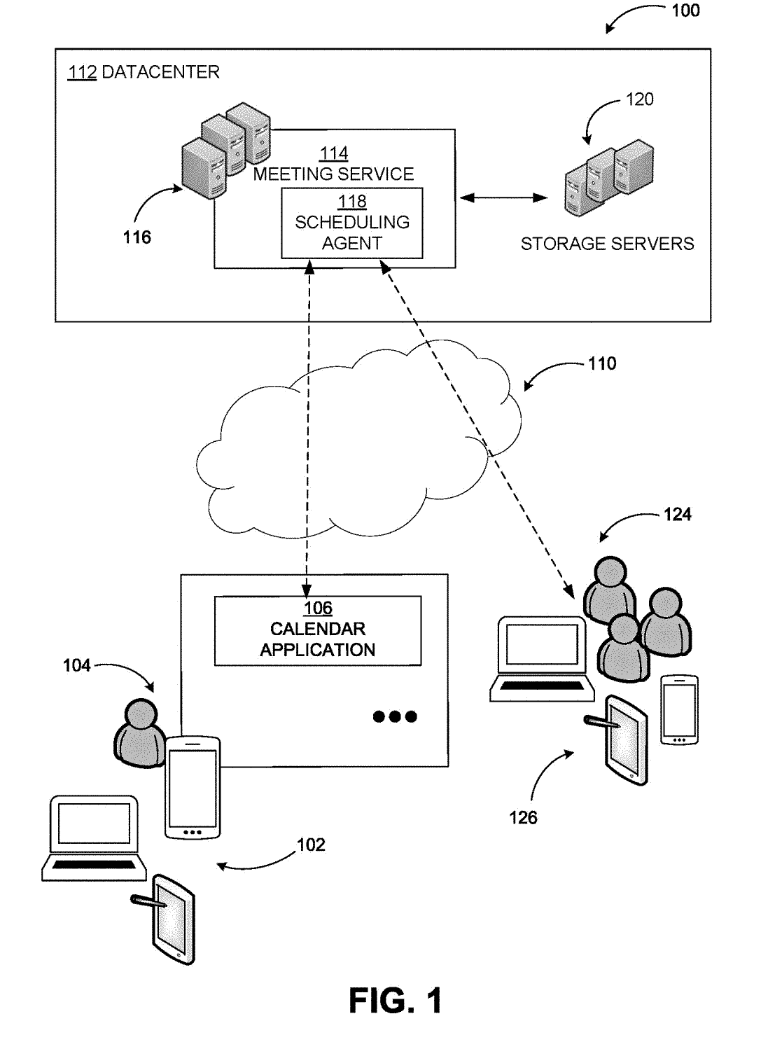

FIG. 1 includes an example network environment where a system to provide cost based auto-negotiation of suitable meeting times may be implemented.

As illustrated in diagram 100, an example system may include a datacenter 112 hosting a cloud-based meeting service 114 configured to provide calendar management and meeting scheduling services, that may be accessed across multiple devices and users. The datacenter 112 may include one or more processing servers 116 configured to execute the meeting service 114, among other components. In some embodiments, at least one of the processing servers 116 may be operable to manage the meeting service 114, where data from devices (such as devices 102 and 126) may be stored at storage servers 120 (or associated data stores). As described herein, the meeting service 114 may be implemented as software, hardware, or combinations thereof.

In some embodiments, the meeting service 114 may be configured to interoperate with various applications to provide meeting management and calendar maintenance. For example, as illustrated, in the diagram 100, a user 104 may execute a thin (e.g., a web browser) or a thick (e.g., a locally installed client application) version of a calendar application 106 through the device 102 with which the meeting service 114 may be configured to integrate and interoperate with over one or more networks, such as network 110. The calendar application 106 may be an application hosted by the meeting service, such as a calendar client, for example. The device 102 may include a desktop computer, a laptop computer, a tablet computer, a vehicle mount computer, a smart phone, or a wearable computing device, among other similar devices. A communication interface may facilitate communication between the meeting service 114 and the calendar application 106 over the network 110.

In an example embodiment, the meeting service 114 may be configured to receive calendar information from individual users. The calendar information may also be stored remotely at the meeting service 114 within the storage servers 120, for example. Cost values may be assigned to time fragments in each of the users' calendars. A suitable meeting time may be auto-negotiated for a meeting to be attended by at least some of the users based on selecting a lower cost time fragment for the meeting. One or more suitable meeting times may be determined as a result of the auto-negotiation and suggested to the attending users for selection.

A system according to embodiments allows cost based auto-negotiation of suitable meeting times. By determining suggested meeting times and optimizing calendars based on assigning cost values to time fragments and negotiating lowest cost times for meetings, increased efficiency, reduced local and cloud computing resource usage, reduced bandwidth usage, and increased security and collaboration may be achieved.

Embodiments, as described herein, address a need that arises from very large scale of operations created by software based services that cannot be managed by humans. The actions/operations described herein are not a mere use of a computer, but address results of a system that is a direct consequence of software used as a service offered in conjunction with large numbers of devices and users maintaining calendars and scheduling meetings.

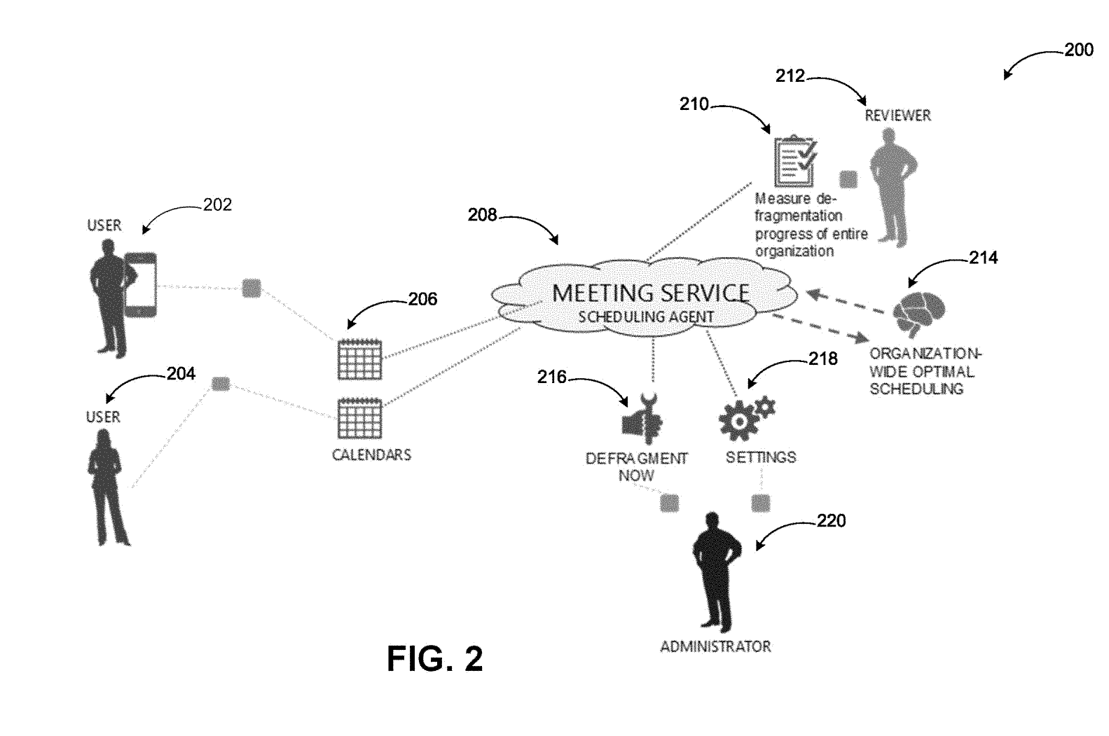

FIG. 2 illustrates conceptually cost based auto-negotiation of suitable meeting times.

As shown in diagram 200, a scheduling agent of a meeting service 208 may allow users 202 and 204 to arrange a meeting through their calendars 206 by using costs assigned to time fragments in the calendars and optimizing for lowest cost for the users 202, 204. The scheduling agent may automatically find free time blocks. If a deadlock occurs voting may be used. Users 202, 204 may also be able to add their own time scheduling preferences.

An administrator 220 may configure scheduling agent settings 218 and initiate defragmentation 216 if multiple users' calendars are being optimized based on cost optimization. The administrator 220 may also monitor progress and defragmentation levels in the calendars. A system scheduling “brain” 214 may sense meeting attendees' calendar whitespace (available times) and fragmentation (distribution of scheduled meetings). The scheduling “brain” 214 may attempt to coalesce meeting times to preserve a maximum amount of contiguous whitespace to achieve higher focus-time blocks for users (time the users can dedicate to their work, personal life, etc.) organization-wide.

The meeting service 208 may also generate reports on defragmentation, which may be reviewed by a reviewer 212 to measure, the progress of the entire organization (210). Thus, according to embodiments, not only can individual meetings optimized, but overall meeting time efficiency of an organization may be enhanced by auto-negotiating suitable meeting times based on, assigned and adjusted cost values to individual time fragments for each user.

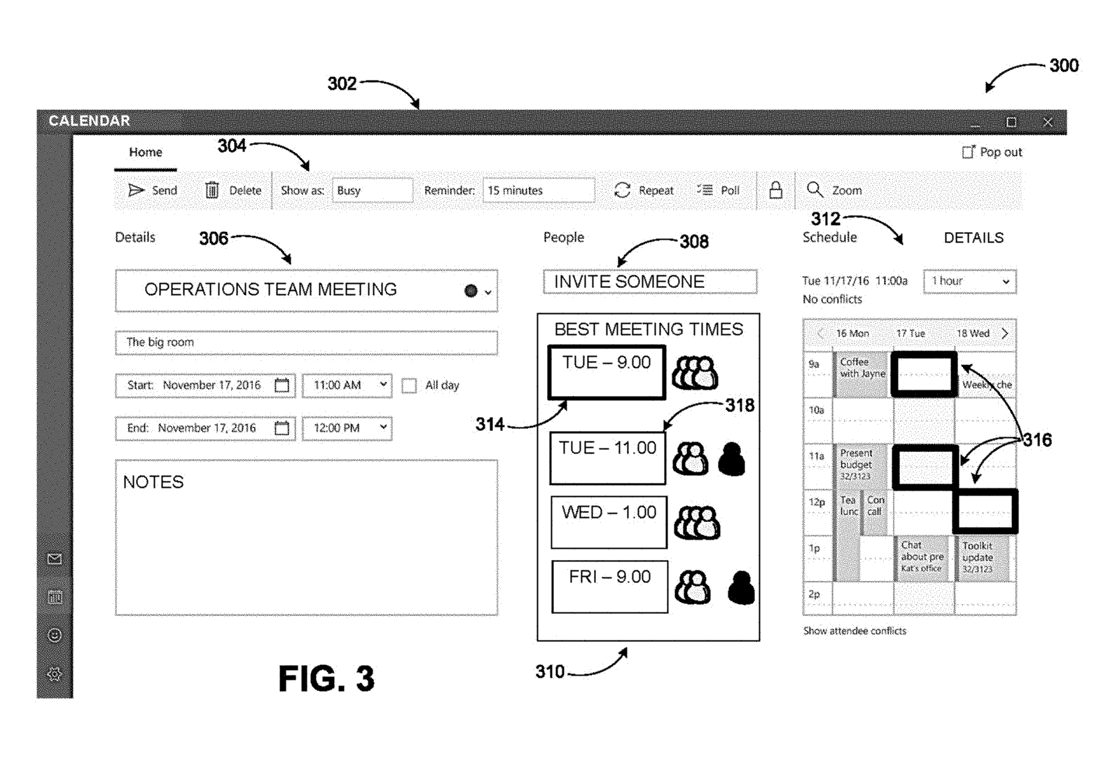

FIG. 3 illustrates an example meeting scheduling user interface for a system with cost based auto-negotiation of suitable meeting times.

Meeting organization user interface 302 in diagram 300 includes meeting related controls 304 such as how to categorize the meeting, whether it will recur, reminder settings, etc. Meeting details 306 may include a title for the meeting, a meeting room selection (or suggestion), meeting time, date, and notes. Attendees may be invited through invitation control 308. A schedule preview 312 may display suggested meeting time(s) 316 within the organizer's schedule to provide the organizer a context within his or her overall schedule. Optionally, a suggested meeting times pane 310 may be provided to show suggested meeting times along with attendee availability. In some examples, a best meeting time 314 may be suggested along with alternative meeting times 316. While the user interface 302 displays information for the organizer of the meeting, other attendees may see similar information on their user interfaces such as who is organizing, who are invited, etc.

As discussed above, time fragments in each user's calendar may be assigned cost value based on factors such as time of day, day of week, other events in the schedules, user behavior, and external factors. For example, an open time fragment in an otherwise busy day filled with other meetings may be assigned a higher cost value compared to one in an open day. More abstract factors may also be considered. For example, if the user is taking a prolonged vacation starting on a Saturday, the time fragments on Friday before the vacation may be assigned higher values to prevent a loaded last day of work before vacation. User's history or explicit preferences may also be factored.

In some embodiments, the cost value based optimization may be performed for a single meeting requested for a group of users. In other embodiments, a user or a group of users' calendars may be analyzed on-demand or based on a predefined period (e.g., once a week or once a month) and existing meetings evaluated for cost based optimization resulting in a defragmented calendar. For example, a meeting service may perform the optimization based on an organization policy.

In the case of a single meeting (or in calendar optimization scenario), a deadline for a meeting may be considered as a hard constraint or factored into the cost. For example, if a group of people have to meet before a certain date, the deadline may simply be used to limit the days. On the other hand, the cost of time fragments may be increased as the deadline approaches to give them time to perform tasks after the meeting.

In some examples, the automatic negotiation with ambient intelligence may be performed using a computational approach such as greedy algorithm or similar ones. User selections/acceptance of suggested meeting times, history of meetings, and usage records may be used in a machine learning algorithm to enhance the scheduling model.

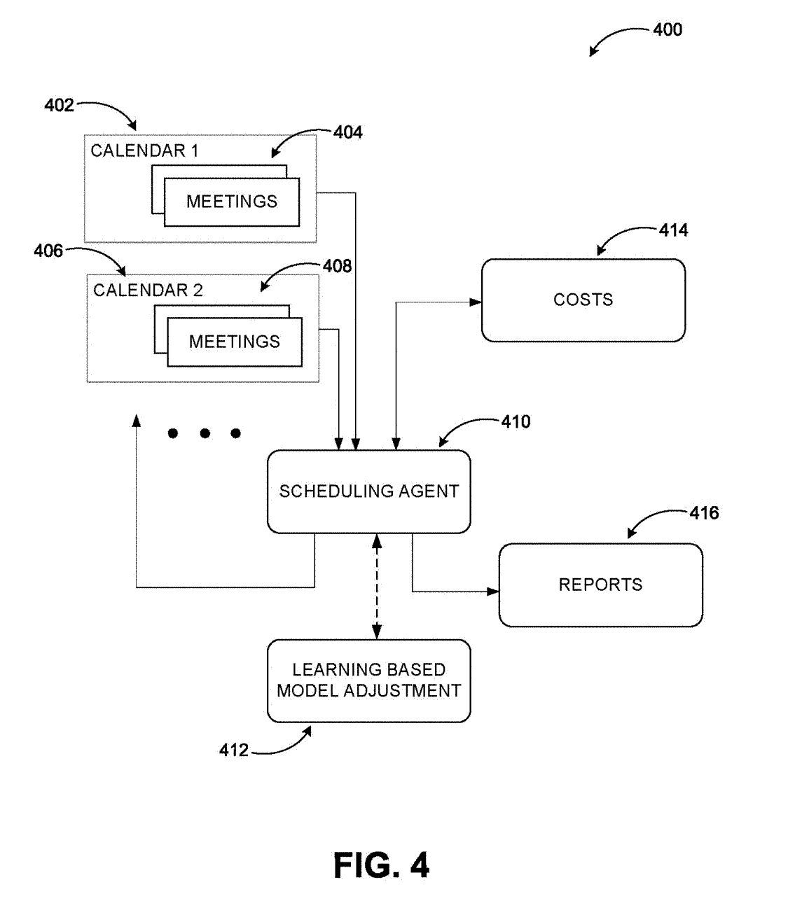

FIG. 4 illustrates example components in providing cost based auto-negotiation of suitable meeting times for defragmentation of multiple calendars.

Diagram 400 shows an example of the scenario, where calendars 402, 406 of multiple users may be optimized to defragment the calendars and optimize the users' schedules. Meeting information associated with meetings 404, 408 may be collected a scheduling agent 410 and costs 414 assigned to the time fragments in the users calendars 402, 406. The scheduling agent 410 may then perform an auto-negotiation (e.g., using greedy algorithm) and adjust the calendars. For example, the optimization may be performed on a regular basis for members of an organization based on organization policies. Individual users may be given the option to accept or reject part or all of the optimization changes. The scheduling agent 410 may also generate reports 416 based on the results for administrators and/or users to review and determine improvements. A learning based model may be adjusted (512) based on the user acceptance selection of the suggested times.

In some embodiments, a single scheduling agent may perform the cost based optimization computations for a meeting service. In other embodiments, multiple scheduling agents responsible for individual users or groups of users may negotiate with each other on behalf of their respective users. For example, the scheduling agents may reside at local computing devices or the users' respective servers (e.g., mailbox servers).

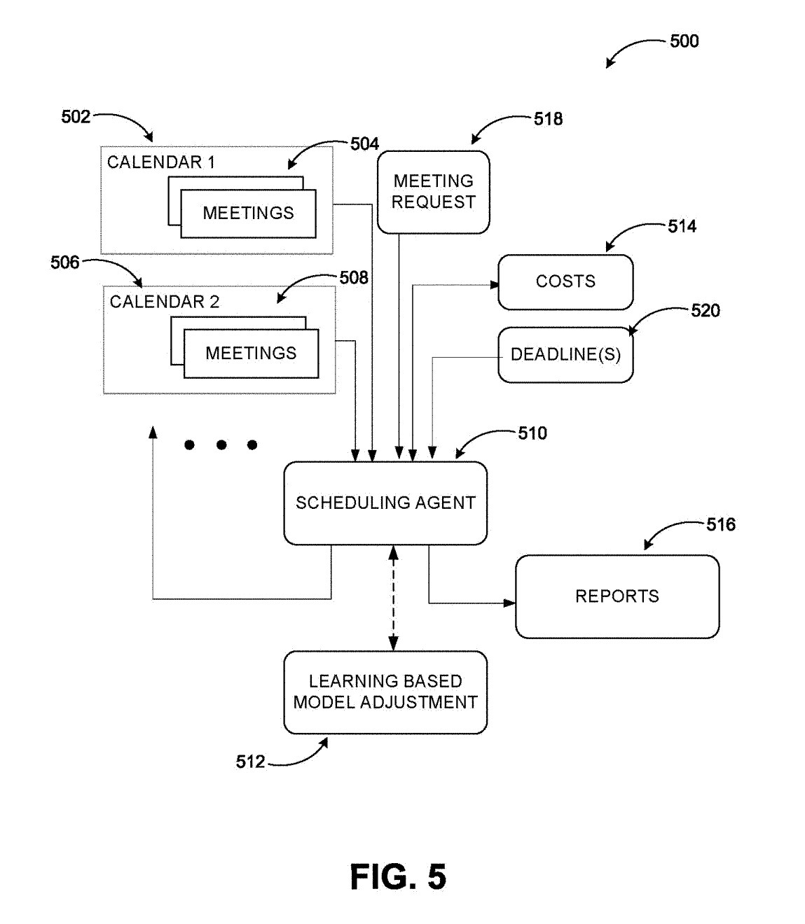

FIG. 5 illustrates example components in providing cost based auto-negotiation of suitable meeting times for scheduling a meeting;

Diagram 500 shows an example of the scenario, where a meeting request 518 may result in a cost, based auto-negotiation by the scheduling agent 510 may result in suggested meeting times for requested attendees of the meeting. Meeting data associated with meetings 504, 508 may be collected from calendars 502, 506 and time fragments assigned costs 514 as discussed above. Deadline(s) 520 for the requested meeting may also be factored into the costs 514. The scheduling agent 510 may then determine one or more suitable times and suggest to the requested attendees. As in FIG. 4, the scheduling agent 510 may also generate reports 516 based on the results for administrators and/or users to review and determine improvements. A learning based model may be adjusted (512) based on the user acceptance selection of the suggested times.

The examples provided in FIGS. 1 through 5 are illustrated with specific systems, services, applications, modules, codes, and notifications. Embodiments are not limited to environments according to these examples. Cost based auto-negotiation of suitable meeting times may be implemented in environments employing fewer or additional systems, services, applications, engines, codes, and user experience configurations. Furthermore, the example systems, services, applications, modules, and notifications shown in FIG. 1 through 5 may be implemented in a similar manner with other values using the principles described herein.

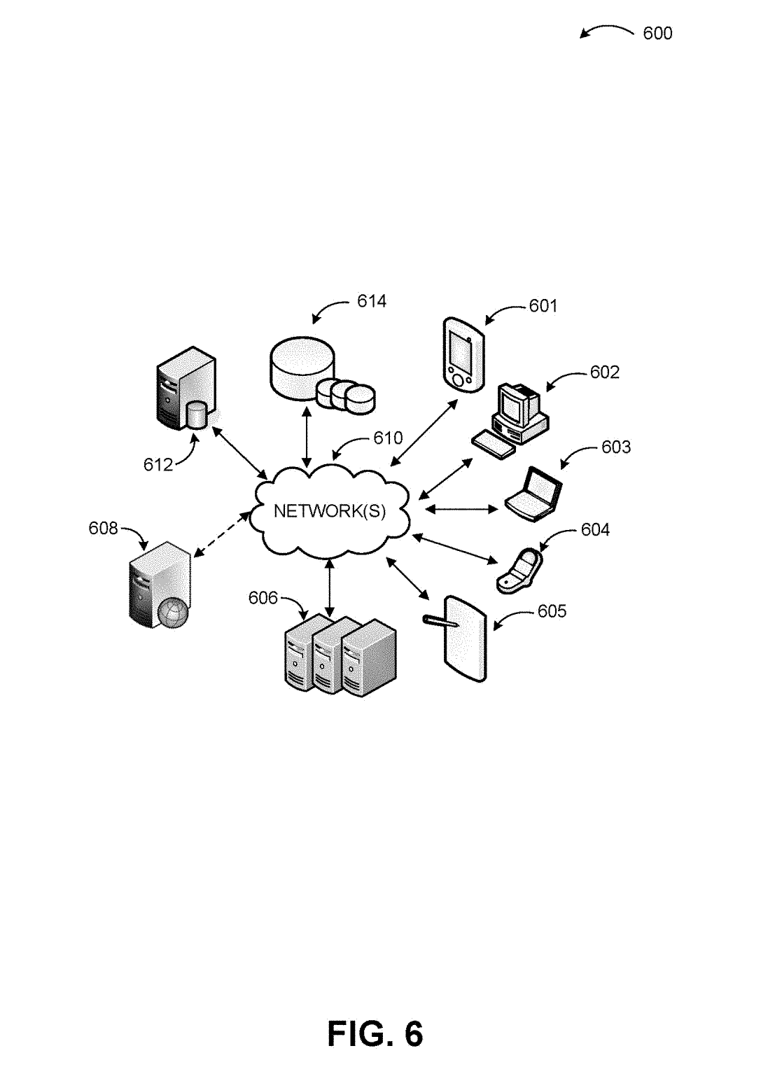

FIG. 6 is a networked environment, where a system according to embodiments may be implemented. In addition to locally installed applications (for example, application 106), cost based auto-negotiation of suitable meeting times may also be employed in conjunction with hosted applications and services (for example, a storage service 114) that may be implemented via software executed over one or more servers 606, individual server 608, or at client devices, as illustrated in diagram 600. A hosted service or application may communicate with client applications on individual computing devices such as a handheld computer 601, a desktop computer 602, a laptop computer 603, a smart phone 604, a tablet computer (or slate), 605 (‘client devices’) through network(s) 610 and control a user interface presented to users.

Client devices 601-605 are used to access the functionality provided by the hosted service or application. One or more of the servers 606 or server 608 may be used to provide a variety of services as discussed above. Relevant data such as meeting data, scheduling model data, and similar, may be stored in one or more data stores (e.g. data store 614), which may be managed by any one of the servers 606 or by database server 612.

Network(s) 610 may comprise any topology of servers, clients, Internet service providers, and communication media. A system according to embodiments may have a static or dynamic topology. Network(s) 610 may include a secure network such as an enterprise network, an unsecure network such as a wireless open network, or the Internet. Network(s) 610 may also coordinate communication over other networks such as PSTN or cellular networks. Network(s) 610 provides communication between the nodes described herein. By way of example, and not limitation, network(s) 610 may include wireless media such as acoustic, RF, infrared and other wireless media.

Many other configurations of computing devices, applications, engines, data sources, and data distribution systems may be employed for cost based auto-negotiation of suitable meeting times. Furthermore, the networked environments discussed in FIG. 6 are for illustration purposes only. Embodiments are not limited to the example applications, engines, or processes.

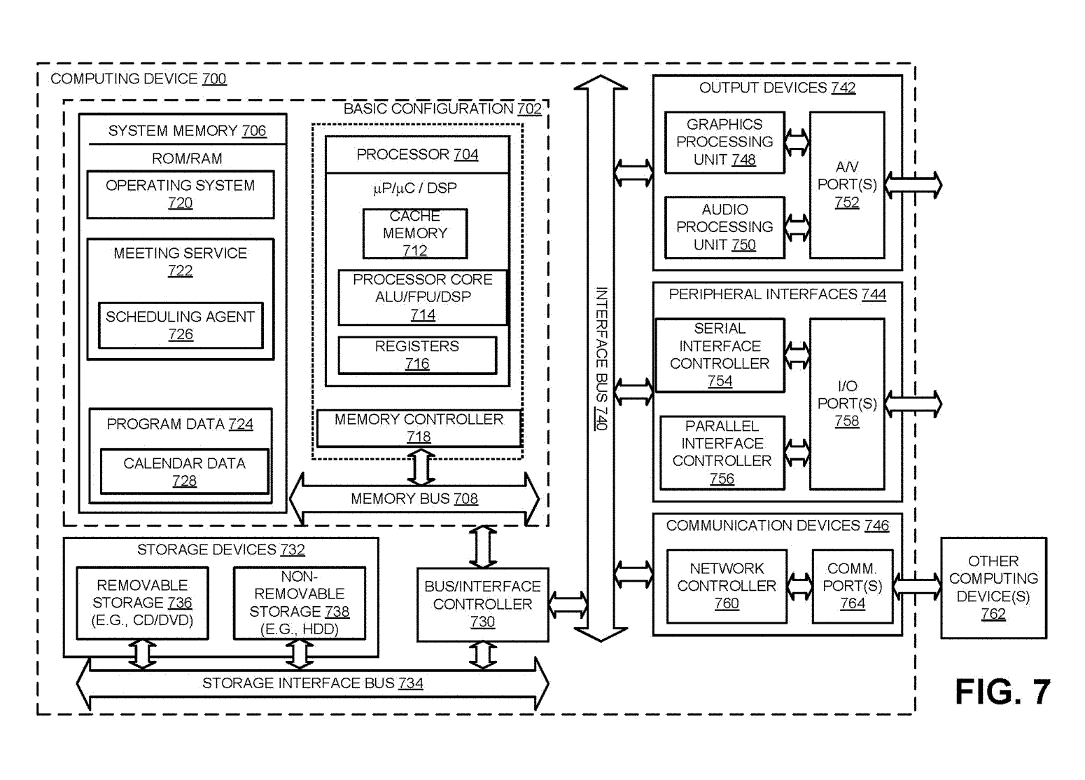

FIG. 7 is a block diagram of an example general purpose computing device, which may be used to provide cost based auto-negotiation of suitable meeting times.

For example, computing device 700 may be used as a server, desktop computer, portable computer, smart phone, special purpose computer, or similar device. In an example basic configuration 702, the computing device 700 may include one or more processors 704 and a system memory 706. A memory bus 708 may be used for communicating between the processor 704 and the system memory 706. The basic configuration 702 is illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as a level cache memory 712, one or more processor cores 714, and registers 716. The example processor cores 714 may (each) include an arithmetic logic unit (ALU), a floating point unit (FPU), a digital signal processing core (DSP Core), or any combination thereof. An example memory controller 718 may also be used with the processor 704, or in some implementations the memory controller 718 may be an internal part of the processor 704.

Depending on the desired configuration, the system memory 706 may be of any type including but not limited to volatile memory (such as RAM), non-volatile memory (such as ROM, flash memory, etc.) or any combination thereof. The system memory 706 may include an operating system 720, a meeting service 722, a scheduling agent 726, and program data 724. The scheduling agent 726 may determine optimal meeting times based on cost based auto-negotiation of suitable meeting times. The program data 724 may include, among other data, meeting data 728, as described herein.

The computing device 700 may have additional features or functionality, and additional interfaces to facilitate communications between the basic configuration 702 and any desired devices and interfaces. For example, a bus/interface controller 730 may be used to facilitate communications between the basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 746) to the basic configuration 702 via the bus/interface controller 730. Some of the example output, devices 742 include a graphics processing unit 748 and an audio processing unit 750, which may be configured to communicate to various external devices such as a display or speakers via one or more A/V ports 752. One or more example peripheral interfaces 744 may include a serial interface controller 754 or a parallel interface controller 756, which may be configured to communicate with external devices such as input devices (for example, keyboard, mouse, pen, voice input device, touch input device, etc.) or other peripheral devices (for example, printer, scanner, etc.) via one or more I/O ports 758. An example communication device 746 includes a network controller 760, which may be arranged to facilitate communications with one or more other computing devices 762 over a network communication link via one or more communication ports 764. The one or more other computing devices 762 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media, A “modulated data signal” may be a signal that has one or more of its characteristics set or changed in such a manner as to encode information in the signal. By way of example, and not limitation, communication media, may include wired, media such as a wired network or direct-wired connection, and wireless media such as acoustic, radio frequency (RF), microwave, infrared (IR) and other wireless media. The term computer readable media as used herein may include both storage media and communication media.

The computing device 700 may be implemented as a part of a general purpose or specialized server, mainframe, or similar computer that includes any of the above functions. The computing device 700 may also be implemented as a personal computer including both laptop computer and non-laptop computer configurations.

Example embodiments may also include methods to provide cost based auto-negotiation of suitable meeting times. These methods can be implemented in any number of ways, including the structures described herein. One such way may be by machine operations, of devices of the type described in the present disclosure. Another optional way may be for one or more of the individual operations of the methods, to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

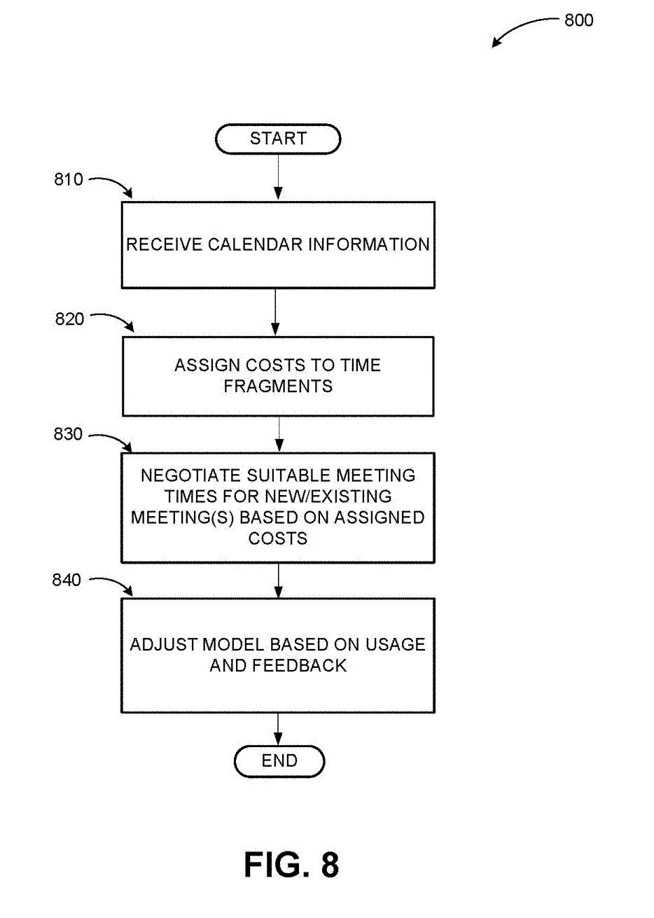

FIG. 8 illustrates a logic flow diagram of a method to provide cost based auto-negotiation of suitable meeting times.

Process 800 may be implemented on a computing device, server, or other system. An example system may include a computer communicatively coupled to a cloud server hosting a meeting service.

Process 800 begins with operation 810, where calendar information associated with a plurality of users may be received and cost values may be assigned to time fragments in each of the plurality of users' calendars at operation 820. The cost values may be based on time of day, day of week, other events in the schedules, user behavior, and external factors. At operation 930, a suitable meeting time may be auto-negotiated for a meeting to be attended by at least some of the plurality of users based on selecting a lower cost time fragment for the meeting.

In some examples, a deadline for the meeting may be considered as a hard constraint or factored into the costs. One or more suitable meeting times may be determined as a result of the auto-negotiation and suggested to the at least some of the plurality of users for selection. At operation 840, a cost-based scheduling model may be adjusted based on usage history and feedback such as selection of suggested times.

The operations included in process 800 are for illustration purposes. Cost based auto-negotiation of suitable meeting times may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to some examples, a means for providing cost based auto-negotiation of suitable meeting times is described. The means may include a means for receiving calendar information associated with a plurality of users; a means for assigning cost values to time fragments in each of the plurality of users' calendars; a means for auto-negotiating a suitable meeting time for a meeting to be attended by at least some of the plurality of users based on selecting a lower cost time fragment for the meeting; and a means for determining one or more suitable meeting times to suggest to the at least some of the plurality of users for selection.

According to some examples, a method to provide cost based auto-negotiation of suitable meeting times is described. The method, may include receiving calendar information associated with a plurality of users; assigning cost values to time fragments in each of the plurality of users' calendars; auto-negotiating a suitable meeting time for a meeting to be attended by at least some of the plurality of users based on selecting a lower cost time fragment for the meeting; and determining one or more suitable meeting times to suggest to the at least some of the plurality of users for selection.

According to other examples, the method may include adjusting a scheduling model based user selection of the suggested one or more suitable meeting times. Assigning cost values to the time fragments may include incrementing or decrementing a base cost value based on one or more of a time of day, a day of week, one or more other events in a user's schedule a meeting type, a past user behavior, and one or more external factors. The extraneous factors may include one or more of a traffic condition, a weather condition, and a nearby event. The method may also include receiving a deadline for the meeting; and constraining available times based on the deadline.

According to further examples, the method may include receiving a deadline for the meeting; and adjusting the cost values based on, the deadline. The method may also include employing greedy algorithm for the auto-negotiation. The method may further include enabling a user to customize one or more cost values. The method may also include customizing one or more cost values based on an organizational policy.

According to other examples, a computing device to provide cost based auto-negotiation of suitable meeting times is described. The computing device may include a communication interface configured to facilitate communication between the computing device and one or more servers; a memory configured to store instructions; and one or more processors coupled to the memory, where the one or more processors, in conjunction with the instructions stored in, the memory, are configured to execute a meeting service. The meeting service may include a calendar module configured to maintain calendars for users of the meeting service; and one or more scheduling agents. The agents may be configured to receive calendar information associated with a plurality of users; assign cost value to time fragments in each of the plurality of users' calendars; auto-negotiate a suitable meeting time for a meeting to be attended by at least some of the plurality of users based on selecting a lower cost time fragment for the meeting; determine one or more suitable meeting times to suggest to the at least some of the plurality of users for selection; and adjust a scheduling model based user selection of the suggested one or more suitable meeting times.

According to some examples, the meeting service may include a plurality of scheduling agents, each scheduling agent executed on a server associated with a user, and, the scheduling agents may be configured to auto-negotiate the suitable meeting time for the meeting on behalf of their respective users. The meeting service may also include a plurality of scheduling agents, each scheduling agent executed on a server associated with a group of users, and the scheduling agents may be configured to auto-negotiate the suitable meeting time for the meeting on behalf of their respective group of users. The one or more scheduling agents may be further configured to auto-negotiate suitable meeting times for existing meetings for the plurality of users over a predefined time span; and reschedule the existing meetings based on a result of the auto-negotiated suitable meeting times. The one or more scheduling agents may be further configured to auto-negotiate the suitable meeting times for the existing meetings based on one of an administrator demand and a predefined period. One or more of the predefined time span and the predefined period may be selected based on an organization policy.

According to further examples, a physical computer-readable memory device with instructions stored thereon to provide cost based auto-negotiation of suitable meeting times is described. The instructions may include receiving calendar information associated with a plurality of users; assigning cost value to time fragments in each of the plurality of users' calendars; auto-negotiating suitable meeting times for existing meetings for the plurality of users based on selecting a lower cost time fragment for the existing meetings over a predefined time span; determining one or more suitable meeting times to suggest to the at least some of the plurality of users for selection; and adjusting a scheduling model based user selection of the suggested one or more suitable meeting times.

According to other examples, the instructions may further include automatically rescheduling the existing meetings based on a result of the auto-negotiated suitable meeting times. Cost values may be assigned by incrementing or decrementing a base cost value based, on one or more of a time of day, a day of week, one or more other events in a user's schedule, a meeting type, a past user behavior, and one or more external factors. The instructions may also include updating the past user behavior based on use feedback to rescheduled meetings. The cost values may be assigned based on a type of user.

The above specification, examples and data provide a complete description of the manufacture and use of the composition of the embodiments. Although the subject matter has been described in language specific to structural, features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to provide cost based auto-negotiation of suitable meeting times, the method comprising:
receiving calendar information associated with a plurality of users;
assigning cost values to time fragments in each of the plurality of users' calendars;
auto-negotiating a suitable meeting time, for a meeting to be attended by at least some of the plurality of users based on selecting a lower cost time fragment, for the meeting; and
determining one or more suitable meeting times to suggest to the at least some of the plurality of users for selection.

2. The method of claim 1, further comprising:
adjusting a scheduling model based user selection of the suggested one or more suitable meeting times.

3. The method of claim 2, wherein assigning cost values to the time fragments comprises:
incrementing or decrementing a base cost value based on one or more of a time of day, a day of week, one or more other events in a user's schedule, a meeting type, a past user behavior, and one or more external factors.

4. The method of claim 3, wherein the extraneous factors include one or more of a traffic condition, a weather condition, and a nearby event.

5. The method of claim 1, further comprising:
receiving a deadline for the meeting; and
constraining available times based on the deadline.

6. The method of claim 1, further comprising:
receiving a deadline for the meeting; and
adjusting the cost values based on the deadline.

7. The method of claim 1, further comprising:
employing greedy algorithm for the auto-negotiation.

8. The method of claim 1, further comprising:
enabling a user to customize one or more cost values.

9. The method of claim 1, further comprising:
customizing one or more cost values based on an organizational policy.

10. A computing device to provide cost based auto-negotiation of suitable meeting times, the computing device comprising:
a communication interface configured to facilitate communication between the computing device and one or more servers;
a memory configured to store instructions; and
one or more processors coupled to the memory, wherein the one or more processors, in conjunction with the instructions stored in the memory, are configured to execute a meeting service, the meeting service comprising:
a calendar module configured to maintain calendars for users of the meeting service; and
one or more scheduling agents configured to:
receive calendar information associated with a plurality of users;
assign cost value to time fragments in, each of the plurality of users' calendars;
auto-negotiate a suitable meeting time for a meeting to be attended by at least some of the plurality of users based on selecting a lower cost time fragment for the meeting;
determine one or more suitable meeting times to suggest to the at least some of the plurality of users for selection; and
adjust a scheduling model based user selection of the suggested one or more suitable meeting times.

11. The computing device of claim 10, wherein the meeting service comprises a plurality of scheduling agents, each scheduling agent executed on a server associated with a user, and wherein the scheduling agents are configured to auto-negotiate the suitable meeting time for the meeting on behalf of their respective users.

12. The computing device of claim 10, wherein the meeting service comprises a plurality of scheduling agents, each scheduling agent executed on a server associated with a group of users, and wherein the scheduling agents are configured to auto-negotiate the suitable meeting time for the meeting on behalf of their respective group of users.

13. The computing device of claim 10, wherein the one or more scheduling agents are further configured to:
auto-negotiate suitable meeting times for existing meetings for the plurality of users over a predefined time span; and
reschedule the existing meetings based on a result of the auto-negotiated suitable meeting times.

14. The computing device of claim 13, wherein the one or more scheduling agents, are further configured to:
auto-negotiate the suitable meeting times for the existing meetings based on one of an administrator demand and a predefined period.

15. The computing device of claim 14, wherein one or more of the predefined time span and the predefined period are selected based on an organization policy.

16. A physical computer-readable memory device with instructions stored thereon to provide cost based auto-negotiation of suitable meeting times, the instructions comprising:
receiving calendar information associated with a plurality of users;
assigning cost value to time fragments in each of the plurality of users' calendars;
auto-negotiating suitable meeting times for existing meetings for the plurality of users based on selecting a lower cost time fragment for the existing meetings over a predefined time span;
determining one or more suitable meeting times to suggest to the at least some of the plurality of users for selection; and
adjusting a scheduling model based user selection of the suggested one or more suitable meeting times.

17. The computer-readable memory device of claim 16, wherein the instructions further comprise:
automatically rescheduling the existing meetings based on a result of the auto-negotiated suitable meeting times.

18. The computer-readable memory device of claim 16, wherein cost values are assigned by incrementing or decrementing abase cost value based on one or, more of a time of day, a day of week, one or more other events in a user's schedule, a meeting type, a past user behavior, and one or more external factors.

19. The computer-readable memory device of claim 18, wherein the instructions further comprise:
updating the past user behavior based on use feedback to rescheduled meetings.

20. The computer-readable memory device of claim 16, wherein the cost values are assigned based on a type of user.
